(19) United States
(12) Patent Application Publication
(10) Pub. No.: US 2025/0229338 A1
(43) Pub. Date: Jul. 17, 2025

(54) DEVICE AND METHOD FOR RENDERING INERT A PROCESS CHAMBER FOR THE ADDITIVE MANUFACTURE OF A WORKPIECE

(71) Applicant: TRUMPF Laser- und Systemtechnik SE, Ditzingen (DE)

(72) Inventors: Jakob Kaiser, Mannheim (DE); Florian Schaede, Stuttgart (DE)

(21) Appl. No.: 19/097,915

(22) Filed: Apr. 2, 2025

Related U.S. Application Data
(63) Continuation of application No. PCT/EP2023/078508, filed on Oct. 13, 2023.

(30) Foreign Application Priority Data
Oct. 28, 2022 (DE) 10 2022 128 598.7

(51) Int. Cl. B22F 12/70; B22F 10/28; B23K 26/12; B23K 26/342; B33Y 30/00

(52) U.S. Cl. CPC B22F 12/70; B23K 26/123; B23K 26/127; B23K 26/342; B33Y 30/00; B22F 10/28; B22F 2201/10

(57) ABSTRACT

A device for additive manufacture of a workpiece includes a process chamber for constructing the workpiece, a gas inlet for introducing an inert gas into the process chamber, and a gas outlet from the process chamber for discharging the inert gas. The gas inlet has a fluidizing cushion. The fluidizing cushion includes a plate with a plurality of grilles arranged one behind the other in a flow direction in order to achieve a uniform gas flow.

### CROSS REFERENCE TO RELATED APPLICATIONS

This application is a continuation of International Application No. PCT/EP2023/078508 (WO 2024/088795 A1), filed on Oct. 13, 2023, and claims benefit to German Patent Application No. DE 10 2022 128 598.7, filed on Oct. 28, 2022. The aforementioned applications are hereby incorporated by reference herein.

### FIELD

Embodiments of the present invention relate to a device for additive manufacture of a workpiece.

### BACKGROUND

Such a generic device is known from WO 2019/162190 A1, in which an inert gas is flowed through a process chamber used for the additive manufacture of three-dimensional structures. According to WO 2019/162190 A1, the inert gas is introduced into the process chamber at specific points.

Furthermore, WO 2018/086887 A1 teaches the use of a porous wall to allow gas to enter a process chamber.

### SUMMARY

Embodiments of the present invention provide a device for additive manufacture of a workpiece. The device includes a process chamber for constructing the workpiece, a gas inlet for introducing an inert gas into the process chamber, and a gas outlet from the process chamber for discharging the inert gas. The gas inlet has a fluidizing cushion. The fluidizing cushion includes a plate with a plurality of grilles arranged one behind the other in a flow direction in order to achieve a uniform gas flow.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic diagram of a device for the additive manufacturing of a workpiece in a process chamber according to some embodiments, wherein FIG. 1 illustrates the rendering inert of a part of the process chamber which is actively flowed through during the construction of the workpiece;

FIG. 2 shows a schematic diagram of the device of FIG. 1 according to some embodiments, wherein FIG. 2 illustrates the rendering inert of a part of the process chamber through which no active flow takes place during the construction of the workpiece; and

FIG. 3 shows a schematic diagram of the device from FIGS. 1 and 2 according to some embodiments, wherein FIG. 3 shows the active flow through the process chamber taking place during the construction of the workpiece.

### DETAILED DESCRIPTION

Embodiments of the invention provide a device and a method which provide a significantly more effective rendering inert of a process chamber.

Embodiments of the present invention provide a device for additive manufacture of a workpiece. The device has a process chamber in which the workpiece can be additively constructed. The device also has a gas inlet and a gas outlet on the process chamber for passing inert gas through the process chamber for rendering inert the process chamber and/or establishing a gas flow in the manufacturing process, in which the gas inlet has a fluidizing cushion. The fluidizing cushion has a plate with a plurality of grilles arranged one behind the other with respect to the flow direction of the fluidizing cushion. The fluidizing cushion enables a particularly uniform, essentially laminar and vortex-free gas flow. This allows the gas in the process chamber to be displaced by inert gas flowing as a block. In contrast to the prior art, there is practically no turbulence and dilution of the gas in the process chamber with inert gas, but rather the gas in the process chamber is effectively and quickly pushed out of the process chamber by the front “wall” of the inert gas block. The rendering inert of the process chamber can thus be achieved very quickly and with very little inert gas.

The plate of the fluidizing cushion can be designed in the form of a wire mesh composite plate. The outer grille or the outer wire mesh layers can have flattened peaks to optimize the outflow behavior. The fluidizing cushion preferably has a pore size of between 5 μm and 500 μm.

The plate of the fluidizing cushion can be curved in order to achieve a particularly laminar gas flow adapted to the design of the process chamber.

The fluidizing cushion can be used for rendering inert a part, in particular a large part, of the piping to/from the process chamber.

The gas inlet may have a T-shaped pipe section. In a particularly preferred embodiment of the invention, the gas inlet has a Y-shaped pipe section. The trunk (the lower part of the Y-shape) preferably faces the process chamber. The fluidizing cushion can be arranged on a first branch of the Y-shape so that inert gas can flow essentially in a straight line into the process chamber.

The second branch of the Y-shape can lead to a pump of the device. The pump can be fluidically arranged between the gas outlet and the second branch. A filter can be installed on the pump.

In order to achieve a particularly straight flow through the process chamber, the gas inlet and the gas outlet can be arranged opposite one another. The additive construction can be provided between the gas inlet and the gas outlet, in particular in a construction cylinder.

The rendering inert of the process chamber can be carried out even more effectively if the device has at least one further fluidizing cushion for introducing a flow of inert gas into the process chamber. The at least one further fluidizing cushion can be arranged on the inside of a first chamber wall of the process chamber. The at least one further fluidizing cushion has a plate with a plurality of grilles.

A further gas outlet can be provided opposite the at least one further fluidizing cushion, so that inert gas can flow into the process chamber essentially in a straight line from the at least one further fluidizing cushion, through the process chamber, and out of the further gas outlet.

The plate of the at least one further fluidizing cushion can be curved in order to achieve a particularly laminar gas flow adapted to the design of the process chamber. The at least one further fluidizing cushion and the fluidizing cushion can designed identically.

The at least one further fluidizing cushion preferably covers the majority of the inner side of the first chamber wall, in particular almost completely, particularly preferably completely. Alternatively, the majority of the inner side of the first chamber wall can be covered by a plurality of further fluidizing cushions, in particular almost completely, particularly preferably completely. The plurality of further fluidizing cushions each have a plate with a plurality of grilles. The plurality of further fluidizing cushions can be designed identically, in particular identically to the fluidizing cushion.

In a particularly preferred embodiment of the invention, the device for additive manufacturing of the workpiece is designed in a powder bed. The device is preferably designed for powder bed-based laser melting (laser metal fusion process).

Embodiments of the invention also provide a method for rendering inert a device described herein comprising the following method step:
A1) introducing a flow of inert gas into the process chamber via the fluidizing cushion and discharging gas (air) out of the process chamber via the gas outlet. During this method step, additive manufacturing of the workpiece is preferably not carried out and/or the pump is switched off.

Method step A1 therefore preferably represents a step for rendering inert the process chamber before the actual construction of the workpiece.

The method preferably also has the following method steps:

B) switching on the pump and the additive construction of the workpiece.

During method step B, preferably no flow of inert gas is introduced via the fluidizing cushion. However, rendering inert can preferably be carried out using the fluidizing cushion before the process starts while the pump is running and/or it can be temporarily subsequently rendered inert using the fluidizing cushion during the additive construction of the workpiece.

Before or after method step A1 and before method step B, the following method step preferably takes place:

A2) introducing a flow of inert gas via the at least one, in particular a plurality of further fluidizing cushions and discharging gas via the further gas outlet. During this method step, additive manufacturing of the workpiece is preferably not carried out and/or the pump is switched off.

Method step A1 therefore preferably represents a step for rendering inert the process chamber before the actual construction of the workpiece.

A noble gas and/or nitrogen are preferably used as the inert gas.

The features mentioned above and the features still to be explained may each be used on their own or together in any desired combinations according to embodiments of the invention. The embodiments shown and described should not be understood as an exhaustive list, but rather are of an exemplary character.

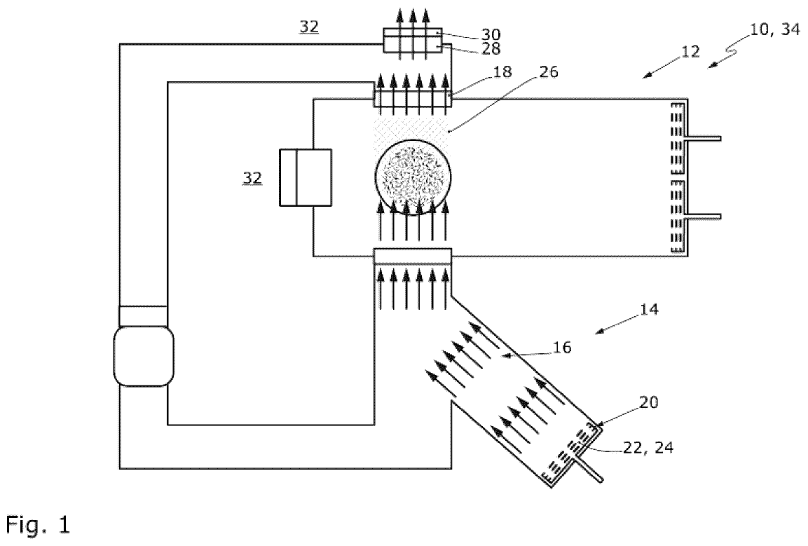

FIGS. 1-3 further illustrate a method according to embodiments of the invention.

FIG. 1 shows a device 10 for additive manufacturing with a process chamber 12, a gas inlet 14 for introducing inert gas 16 and a gas outlet 18 for discharging the inert gas 16. The inert gas 16 is preferably in the form of a noble gas or nitrogen.

The flow of inert gas 16 is introduced via a fluidizing cushion 20, which has a plate 22 with a plurality of grilles 24. The grilles 24 produce a very laminar gas flow with very little turbulence. As a result, the inert gas 16 is discharged as a block and pushes gas 26 present in the process chamber 12 out of the process chamber 12 via the gas outlet 18. A first valve 28, possibly with a filter 30, can be provided to the surrounding atmosphere 32.

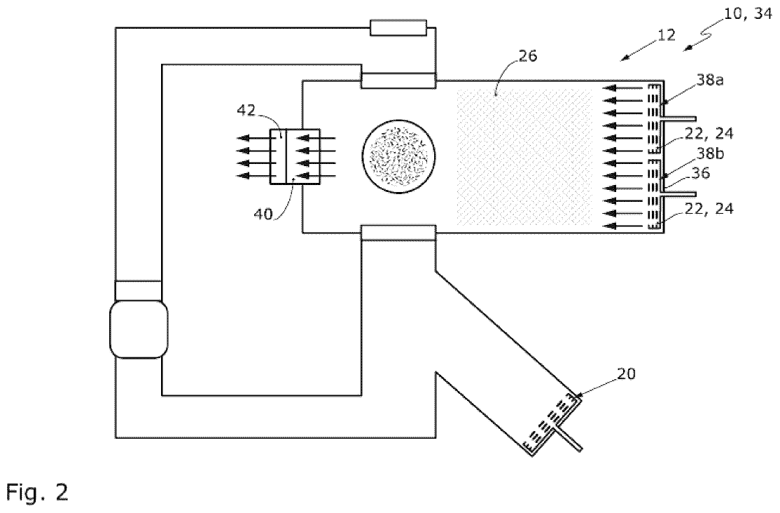

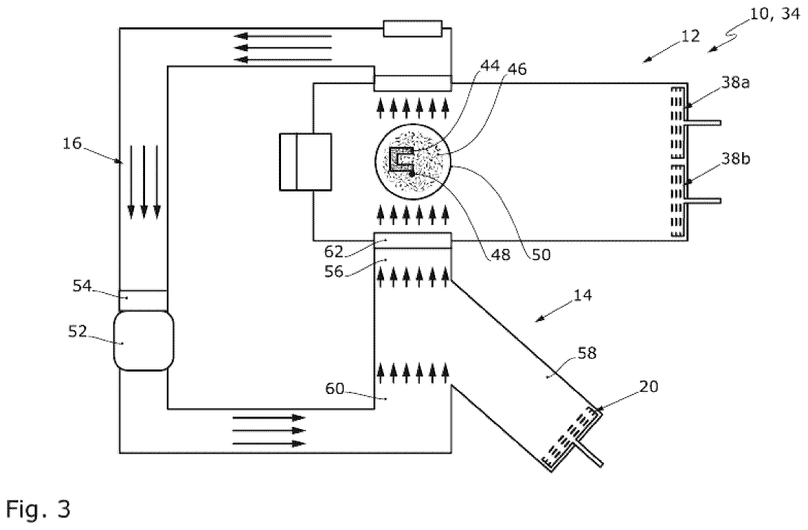

FIG. 1 shows a first step of a method 34 for rendering inert the process chamber 12. Further method steps are shown in FIGS. 2 and 3.

FIG. 2 shows the device 10 or the method 34 with the process chamber 12, wherein it can be seen from FIG. 2 that no inert gas flow takes place from the fluidizing cushion 20.

The process chamber 12 has a first chamber wall 36, the inside of which is completely covered by further fluidizing cushions 38a, 38b. The further fluidizing cushions 38a, b each have a plate 22 with a plurality of grilles 24. Inert gas 16 flows as a block from the further fluidizing cushions 38a, b in order to push gas 26 as a block out of the process chamber 12 from a further gas outlet 40, and possibly a further filter 42.

FIG. 3 shows the device 10 or the method 34 during the manufacture of a workpiece 44 by melting a powder layer in certain areas 46 using a laser beam 48. The additive manufacturing is preferably carried out in a construction cylinder 50.

A pump 52 circulates inert gas 16—if necessary through a pre-filter 54—during the additive manufacturing of the workpiece 44. The pre-filter 54 can be designed in the form of a filter unit.

Generally speaking, a filter fluidizing cushion (not shown) can be provided on the pre-filter 54, which is in particular designed identically to the fluidizing cushion 20.

The fluidizing cushion 20 and the other fluidizing cushions 38a, b are preferably switched off unless an oxygen sensor (not shown) measures a significant increase in the oxygen content.

It can be seen from FIG. 3 that the gas inlet 14 is Y-shaped, and has a trunk 56, a first branch 58 and a second branch 60. The fluidizing cushion 20 is arranged in the first branch 58. The second branch 60 leads to the pump 52. The trunk 56 leads—here via a honeycomb-shaped distributor 62—into the interior of the process chamber 12.

As described above, embodiments of the invention relate to a device 10 for the additive manufacturing of a workpiece 44. The device 10 has at least one fluidizing cushion 20 in order for inert gas 16 to flow uniformly and as a block into the interior of a process chamber 12. This allows the process chamber 12 to be effectively rendered inert. A gas outlet 18 is preferably arranged opposite a gas inlet 14 with the fluidizing cushion 20. Embodiments of the invention further relate to a method 34 for operating such a device 10. In the method 34, the process chamber 12 is preferably rendered inert by the fluidizing cushion 20 before the additive manufacture of the workpiece 44 begins, while a pump 52 makes inert gas 16 flow through the process chamber 12 during the additive manufacturing process.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 Device
12 Process chamber
14 Gas inlet
16 Inert gas
18 Gas outlet
20 Fluidizing cushion
22 Plate
24 Grille
26 Gas
28 First valve
30 Filter
32 Surrounding atmosphere
34 Method
36 First chamber wall
38a, b Further fluidizing cushions
40 Further gas outlet
42 Further filter
44 Workpiece
46 Powder layer
48 Laser beam
50 Construction cylinder
52 Pump
54 Pre-filter
56 Trunk (of the Y-shape)
58 First branch (of the Y-shape)
60 Second branch (of the Y-shape)
62 Honeycomb-shaped distributor

1. A device for additive manufacture of a workpiece, the device comprising:
a process chamber for constructing the workpiece;
a gas inlet for introducing an inert gas into the process chamber; and
a gas outlet from the process chamber for discharging the inert gas;
wherein the gas inlet has a fluidizing cushion, wherein the fluidizing cushion comprises a plate with a plurality of grilles arranged one behind the other in a flow direction in order to achieve a uniform gas flow.

2. The device according to claim 1, wherein the gas inlet is Y-shaped, wherein a trunk of the Y-shape opens directly or indirectly into the process chamber, and wherein the fluidizing cushion is arranged on a first branch of the Y-shape, so that a flow of the inert gas is capable of being introduced into the process chamber via the trunk of the Y-shape.

3. The device according to claim 2, further comprising a pump, wherein a second branch of the Y-shape is connected to the pump, wherein the pump is connected at another end to the gas outlet of the process chamber, so that the inert gas is capable of being sucked out of the gas outlet and the flow of the inert gas is capable of being introduced into the process chamber via the pump and the trunk of the Y-shape.

4. The device according to claim 1, wherein the gas inlet and the gas outlet are arranged opposite one another, and wherein the additive manufacture of the workpiece takes place between the gas inlet and the gas outlet.

5. The device according to claim 1, further comprising:
a further fluidizing cushion for introducing a flow of the inert gas into the process chamber, wherein the further fluidizing cushion is arranged on a first chamber wall of the process chamber, wherein the further fluidizing cushion comprises a second plate with a plurality of grilles arranged one behind the other in a second flow direction; and
a further gas outlet arranged in the process chamber opposite the further fluidizing cushion, so that the inert gas is capable of flowing from the further fluidizing cushion through the process chamber and out of the further gas outlet.

6. The device according to claim 5, wherein the further fluidizing cushion covers the first chamber wall.

7. The device according to claim 5, wherein a plurality of further fluidizing cushions is provided, wherein each of the plurality of further fluidizing cushions comprises a respective second plate with a plurality of grilles arranged one behind the other in the second flow direction, wherein the plates cover the first chamber wall.

8. The device according to claim 1, wherein the device is configured for the additive manufacturing of the workpiece in a powder bed.

9. A method for rendering inert a device according to claim 1, the method comprising:
A1) introducing a flow of the inert gas into the process chamber via the fluidizing cushion, and discharging the inert gas from the process chamber via the gas outlet, while no additive manufacture of the workpiece takes place.

10. The method according to claim 9, wherein the device further comprises a pump, the method further comprising:
B) switching on the pump and starting the additive manufacture of the workpiece.

11. The method according to claim 10, wherein in step B, no introduction of the flow of the inert gas via the fluidizing cushion takes place.

12. The method according to claim 9,, wherein the device further comprises:
a further fluidizing cushion for introducing a flow of the inert gas into the process chamber, wherein the further fluidizing cushion is arranged on a first chamber wall of the process chamber, wherein the further fluidizing cushion comprises a second plate with a plurality of grilles arranged one behind the other in a second flow direction; and
a further gas outlet arranged in the process chamber opposite the further fluidizing cushion, so that the inert gas is capable of flowing from the further fluidizing cushion through the process chamber and out of the further gas outlet;
the method further comprising:
A2) introducing a second flow of the inert gas into the process chamber via the further fluidizing cushion, and discharging the inert gas from the process chamber via the further gas outlet, while no introduction of the flow of the inert gas via the fluidizing cushion and no additive manufacture of the workpiece take place, wherein step A2 is carried out before or after step A1.

13. The method according to claim 9, wherein the insert gas comprises a noble gas and/or nitrogen.
